(19) United States
(12) Patent Application Publication
(10) Pub. No.: US 2016/0369844 A1
(43) Pub. Date: Dec. 22, 2016

(54) SLIDE RAIL AND ELECTRONIC APPARATUS

(71) Applicant: FUJITSU LIMITED, Kawasaki-shi (JP)

(72) Inventors: Hisashi ITO, Yokohama (JP); Nobuhiro OGAWA, Kawasaki (JP); Tatsuya Sudo, Kawasaki (JP); HIROSHI TAKAHASHI, KAWASAKI (JP); Michi AMANAI, Yokohama (JP); Kosuke Nakamura, Yokohama (JP); Haruhiko Sakai, Machida (JP)

(73) Assignee: FUJITSU LIMITED, Kawasaki-shi (JP)

(21) Appl. No.: 15/170,358

(22) Filed: Jun. 1, 2016

(30) Foreign Application Priority Data
Jun. 16, 2015 (JP) 2015-120787
Feb. 16, 2016 (JP) 2016-026530

(51) Int. Cl. F16C 29/00; F16C 29/04

(52) U.S. Cl. CPC F16C 29/005; F16C 29/046

(57) ABSTRACT

A slide rail includes: an outer rail; an inner rail, including a space into which a guide pin, which is attached to a to-be-mounted object, is capable of being inserted from one end side of the inner rail, configured to slide in a longitudinal direction of the outer rail; and a locking mechanism configured to fix the inner rail onto the outer rail.

### CROSS-REFERENCE TO RELATED APPLICATIONS

This application is based upon and claims the benefit of priority of the prior Japanese Patent Application No. 2015-120787, filed on Jun. 16, 2015, and No. 2016-026530, filed on Feb. 16, 2016, the entire contents of which are incorporated herein by reference.

### FIELD

The embodiments discussed herein are related to a slide rail and an electronic apparatus.

### BACKGROUND

The related technique is disclosed in Japanese Laid-open Patent Publication No. 2009-61133.

### SUMMARY

According to an aspect of the embodiments, a slide rail includes: an outer rail; an inner rail, including a space into which a guide pin, which is attached to a to-be-mounted object, is capable of being inserted from one end side of the inner rail, configured to slide in a longitudinal direction of the outer rail; and a locking mechanism configured to fix the inner rail onto the outer rail.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an exemplary side view of an electronic apparatus;

FIG. 2 is an exemplary perspective view of a slide rail;

FIG. 3 is an exemplary longitudinal sectional view of the slide rail;

FIG. 4 is an exemplary perspective view of an inner rail;

FIG. 5 is an exemplary cross-sectional view of the inner rail;

FIG. 6 is an exemplary perspective view of an end portion of the inner rail;

FIGS. 7A and 7B are exemplary perspective views each illustrating a stopper;

FIG. 8 is an exemplary side view of the end portion of the slide rail;

FIGS. 9A and 9B are exemplary perspective views each illustrating a lock knob;

FIG. 10 illustrates an example of the inner rail;

FIG. 11 illustrates an example of the positional relationship between arrows, which are formed on the lock knob, and tapered portions;

FIG. 12 illustrates an example of a server;

FIG. 13 illustrates an example of a guide pin;

FIG. 14 illustrates an exemplary method of using the slide rail (an exemplary method of mounting a server);

FIG. 15 illustrates an exemplary method of using the slide rail (an exemplary method of mounting the server);

FIG. 16 illustrates an exemplary method of using the slide rail (an exemplary method of mounting the server);

FIG. 17 illustrates an exemplary method of using the slide rail (an exemplary method of mounting the server);

FIG. 18 illustrates an exemplary method of using the slide rail (an exemplary method of mounting the server);

FIG. 19 illustrates an exemplary method of using the slide rail (an exemplary method of mounting the server);

FIG. 20 illustrates an exemplary method of using the slide rail (an exemplary method of mounting the server);

FIGS. 21A to 21C are diagrams each illustrating an exemplary method of using the slide rail (an exemplary method of mounting the server);

FIG. 22 illustrates an exemplary state where a server has been pulled out from a rack;

FIG. 23 illustrates an exemplary operation for removing a server from the slide rail;

FIG. 24 illustrates an exemplary operation for removing the server from the slide rail;

FIG. 25 illustrates an exemplary operation for removing the server from the slide rail;

FIGS. 26A and 26B are exemplary top views of slide rails;

FIGS. 27A and 27B are exemplary side views of slide rails;

FIG. 28 is an exemplary longitudinal sectional view of the slide rail;

FIGS. 29A and 29B are diagrams illustrating an example of an interlocking mechanism of left and right slide rails;

FIG. 30 illustrates an example of slide rails;

FIGS. 31A and 31B are exemplary perspective views each illustrating the slide rail;

FIGS. 32A and 32B are exemplary perspective views each illustrating the slide rail; and

FIG. 33 illustrates an example of a locking mechanism.

### DESCRIPTION OF EMBODIMENTS

For example, a large number of racks (server racks) are installed in a data center, and a plurality of computers (hereinafter referred to as servers) are accommodated in each of the racks. Jobs are organically assigned to the servers, and a large number of jobs are effectively processed.

Such a server is mounted in a rack by using, for example, two slide rails each of which is arranged on the left or right sides. Each of the slide rails includes an outer rail that is fixed to the inner side of the rack and an inner rail that is caused to slide along the outer rail. The server is fixed to the inner rail and is easily pulled out from the rack as a result of the inner rail sliding.

Using the slide rails enables the server to be easily pulled out from the rack, and accordingly, maintainability of the server is improved.

For example, a slide rail that is capable of being pulled out to a larger length by providing an intermediate rail between an outer rail and an inner rail, is provided. Such slide rails are used in various scenes other than the case of mounting a server. An object that is mounted in a housing, such as a rack, by using slide rails may hereinafter be referred to as a to-be-mounted object.

For example, slide rails are each provided with a locking mechanism in such a manner that the slide rails will not slide when a to-be-mounted object is attached to the slide rails.

When a to-be-mounted object is attached to slide rails, inner rails are pulled out from a housing, and the to-be-mounted object is disposed between the left and right inner rails. Then, the to-be-mounted object and the inner rails are fixed to each other with screws or the like. Protrusions are formed on side portions of the to-be-mounted object, and receiving portions that receive the protrusions are formed in the slide rails. With this configuration, the to-be-mounted object may be easily fixed onto the slide rails.

For example, when the inner rails are pulled out from the housing, the inner rails are likely to swing in the width direction of the housing, and consequently, it may become difficult to perform an operation of fixing the to-be-mounted object onto the inner rails. Since the to-be-mounted object is fixed onto the inner rails while the inner rails have been pulled out, a relatively large work space may be used.

For example, slide rails to and from which a to-be-mounted object is easily attached and removed in a relatively small work space may be provided.

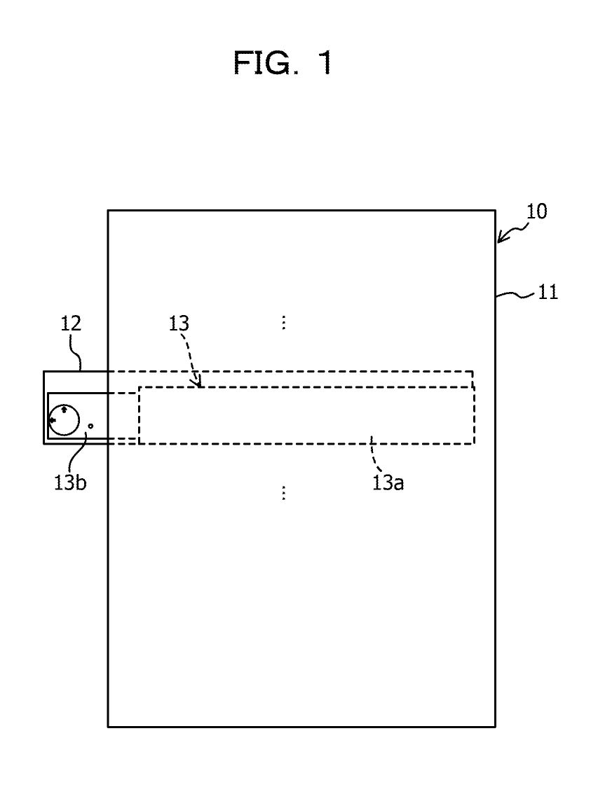

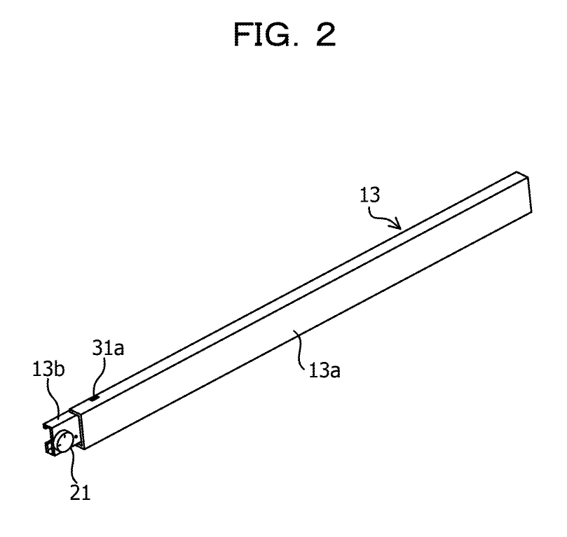

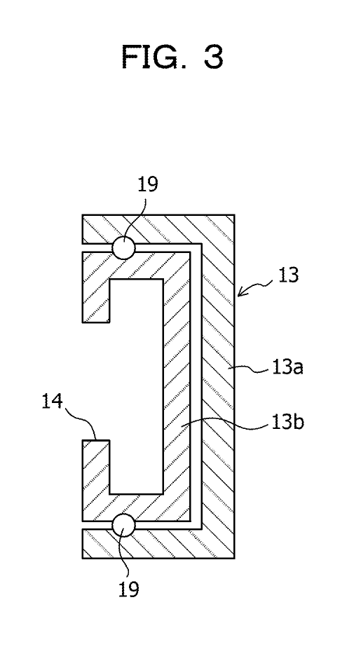

FIG. 1 is an exemplary side view of an electronic apparatus. FIG. 2 is an exemplary perspective view of a slide rail. FIG. 3 is an exemplary longitudinal sectional view of the slide rail.

An electronic apparatus 10 includes a rack 11, a plurality of servers 12 that are arranged in the rack 11 at a certain pitch in the height direction of the rack 11 (only one of the plurality of servers 12 is illustrated in FIG. 1), and slide rails 13 that are disposed between each of the servers 12 and the rack 11. Each two of the slide rails 13 are paired with each other, and each pair of the slide rails 13 is attached to one of the servers 12. Each of the servers 12 may be an example of an electronic device.

Each of the slide rails 13 includes an outer rail 13a that is horizontally fixed to a frame of the rack 11 and an inner rail 13b that is connected to a corresponding one of the servers 12. The inner rail 13b is disposed in an area inside the outer rail 13a and slides in the longitudinal direction of the outer rail 13a. In each of the slide rails 13, in order to cause the inner rail 13b to smoothly slide, ball bearings 19 are disposed between the inner rail 13b and the outer rail 13a as illustrated in FIG. 3.

For convenience of description, a direction in which the inner rail 13b is to be pulled out will hereinafter be referred to as a forward direction, and a direction opposite to the forward direction will hereinafter be referred to as a backward direction.

Although FIG. 1 illustrates a state where one of the servers 12 has been slightly pulled out toward outside the rack 11 (the front side), when the server 12 is operating, the server 12 is accommodated in the rack 11, and a front surface of the rack 11 is closed by a door.

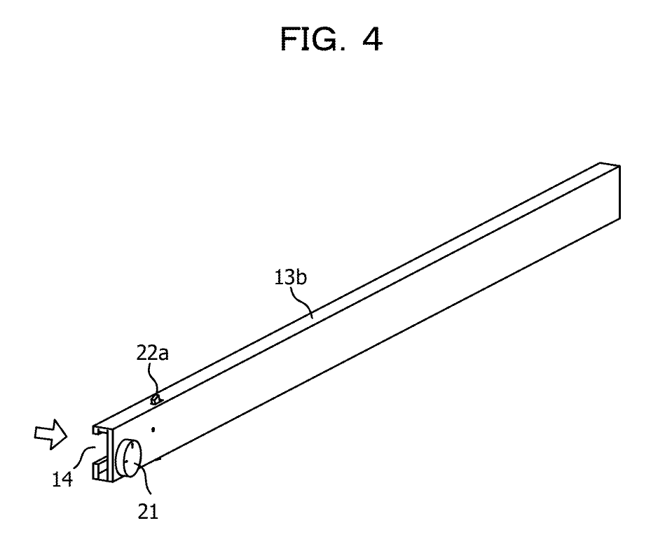

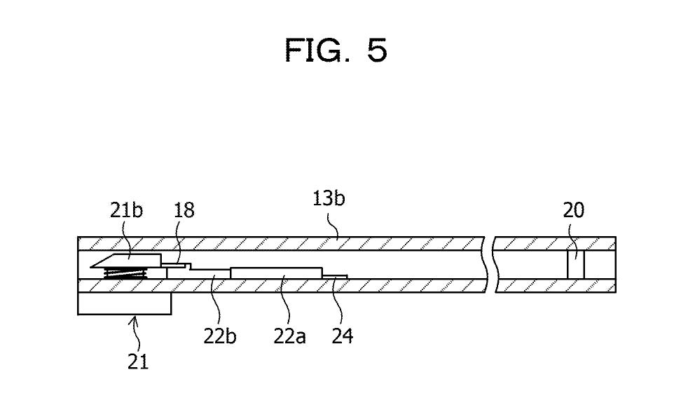

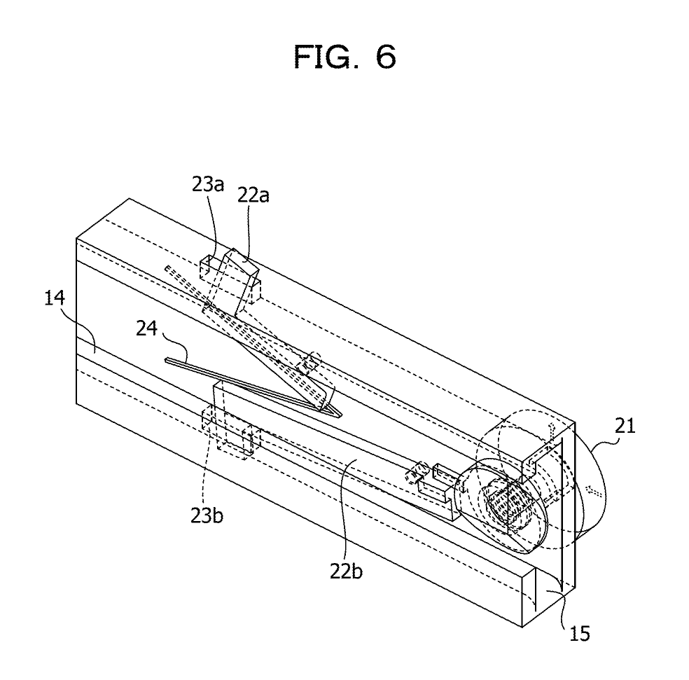

FIG. 4 is an exemplary perspective view of an inner rail. FIG. 5 is an exemplary cross-sectional view of the inner rail. FIG. 6 is an exemplary perspective view of an end portion of the inner rail. FIG. 6 illustrates a perspective view of the end portion of the inner rail 13b as seen from the direction of an arrow in FIG. 4.

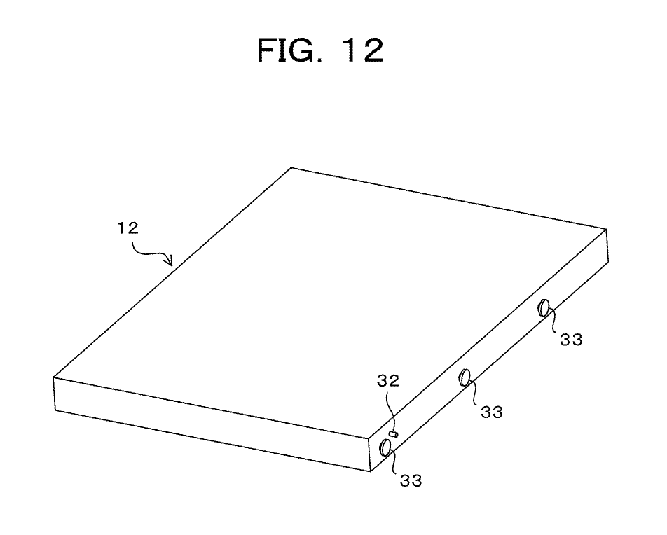

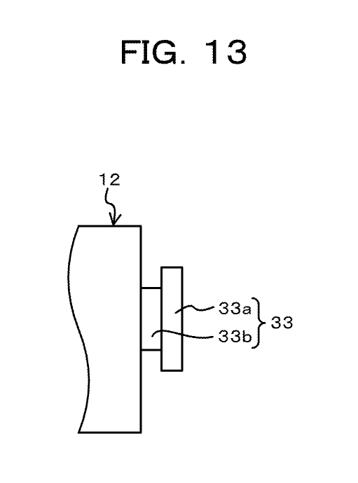

As illustrated in FIG. 4 and FIG. 6, the inner rail 13b may be a member having a substantially square cylindrical shape. For example, a cutout portion 14 is formed in a surface of the inner rail 13b, the surface facing the server 12, from a front end to a rear end of the surface in the longitudinal direction of the inner rail 13b. A space through which larger-diameter portions 33a of guide pins 33 (see FIG. 12 and FIG. 13), the guide pins 33 being attached to the server 12, may pass is formed inside the inner rail 13b. The cutout portion 14 is formed in such a manner as to have a size that allows smaller-diameter portions 33b of the guide pins 33 to pass through the cutout portion 14.

In the inner rail 13b, a stopper 20 that hinders the guide pins 33 from moving further rearward is disposed at a predetermined position on the rear end side of the inner rail 13b. A tapered portion 15 that guides the guide pins 33 into the inner rail 13b is formed at the front end of the inner rail 13b.

A lock knob 21, stoppers 22a and 22b, and a spring 24 are each disposed at a position that is spaced rearward away from the front end of the inner rail 13b by a predetermined distance.

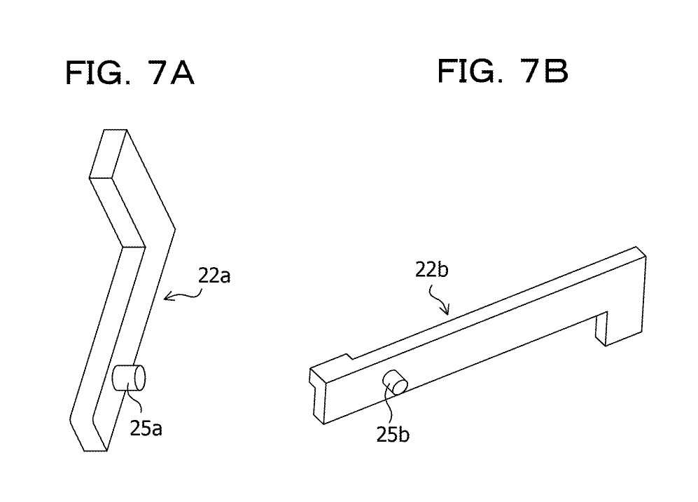

FIGS. 7A and 7B are exemplary perspective views each illustrating a stopper. As illustrated in FIG. 7A, the stopper 22a has a shape whose long axis and short axis are combined with each other in an L shape and moves around a rotary shaft 25a, which is disposed on the long axis side, forward and backward. As illustrated in FIG. 7B, the stopper 22b also has a shape whose long axis and short axis are combined with each other in an L shape and moves around a rotary shaft 25b, which is disposed on the long axis side, forward and backward. The rotary shafts 25a and 25b of the stoppers 22a and 22b are rotatably supported in predetermined holes formed in a side surface of the slide rail 13.

As illustrated in FIG. 6, the stopper 22a is urged by the spring 24, and an end portion of the stopper 22a on the short axis side (hereinafter referred to as an end portion of the stopper 22a) projects upward by passing through a hole 23a formed at a predetermined position in an upper surface of the inner rail 13b. The stopper 22b is also urged by the spring 24, and an end portion of the stopper 22b on the short axis side (hereinafter referred to as an end portion of the stopper 22b) projects downward by passing through a hole 23b formed at a predetermined position in a lower surface of the inner rail 13b.

The stoppers 22a and 22b are substantially simultaneously urged by one spring 24, which has a V shape. For example, the stoppers 22a and 22b may be separately urged by using two springs.

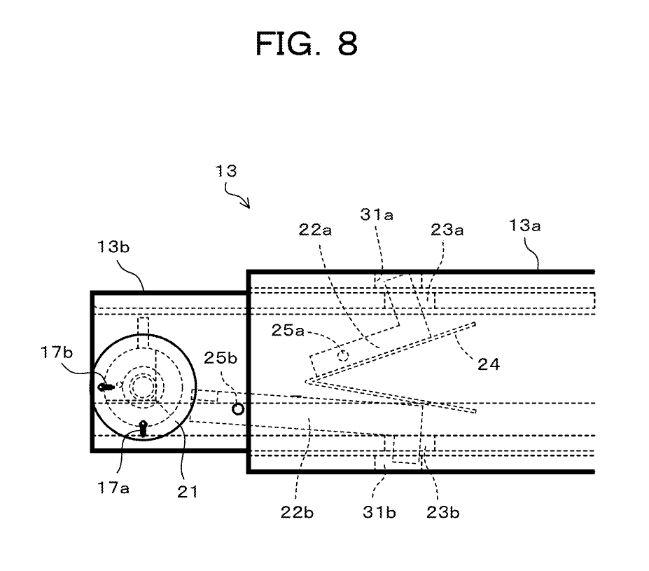

As illustrated in FIG. 8, holes 31a and 31b are formed at predetermined positions in the outer rail 13a, and the end portions of the stoppers 22a and 22b projecting through the holes 23a and 23b are respectively fitted into the holes 31a and 31b. When the inner rail 13b is pulled out from the outer rail 13a to, for example, about 10 cm, the end portions of the stoppers 22a and 22b are respectively fitted into the holes 31a and 31b. After the end portions of the stoppers 22a and 22b have been fitted to the holes 31a and 31b, respectively, the inner rail 13b and the outer rail 13a are locked together, and the inner rail 13b is brought into a state of not capable of sliding. The holes 31a and 31b may be examples of engagement portions with which the stoppers 22a and 22b engage.

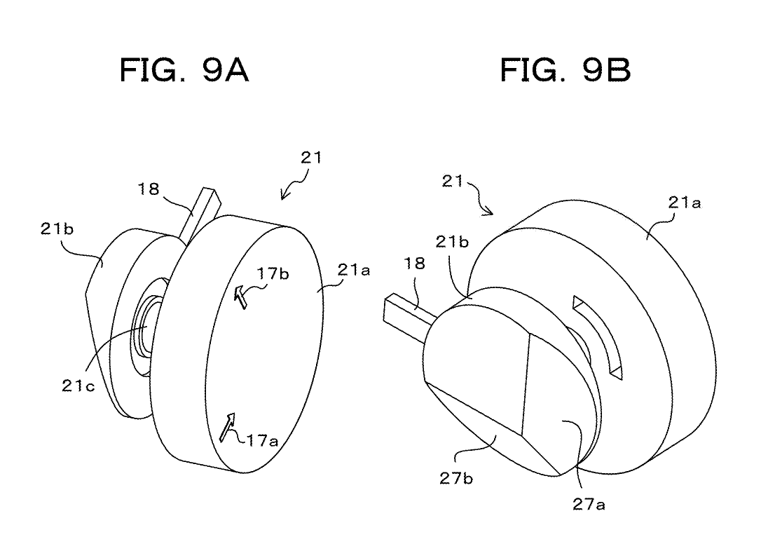

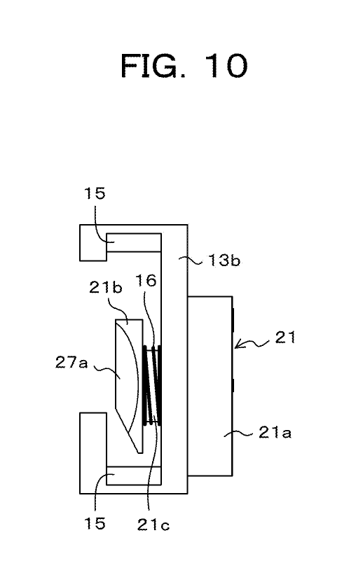

FIGS. 9A and 9B are exemplary perspective views each illustrating a lock knob. FIG. 10 illustrates an example of one of the inner rails. FIG. 10 is a diagram illustrating the inner rail 13b as seen from the front end side.

As illustrated in FIG. 9A and FIG. 9B, the lock knob 21 includes a handle portion 21a, a locking plate 21b, and a connecting portion 21c that connects the handle portion 21a and the locking plate 21b to each other. As illustrated in FIG. 10, the handle portion 21a is disposed outside the inner rail 13b, and the locking plate 21b is disposed inside the inner rail 13b. The connecting portion 21c is rotatably supported in a predetermined hole formed in a side surface of the inner rail 13b. The handle portion 21a and the locking plate 21b are members each having a disc-like shape and are caused to rotate around the connecting portion 21c, which acts as a rotary shaft.

A coil spring 16 is disposed between the side surface of the inner rail 13b and the locking plate 21b. The locking plate 21b is urged by the coil spring 16 in a direction away from the side surface of the inner rail 13b.

As illustrated in FIG. 9A, an arrow 17a that indicates a direction in which the server 12 is mounted and an arrow 17b that indicates a direction in which the server 12 is removed are formed on the handle portion 21a at positions that are displaced from each other by about 90 degrees in the circumferential direction of the handle portion 21a. The tip of the arrow 17a indicating the direction in which the server 12 is mounted is oriented toward the center of the handle portion 21a, and the tip of the arrow 17b indicating the direction in which the server 12 is removed is oriented outward in a radial direction of the handle portion 21a.

As illustrated in FIG. 9B, a first tapered portion 27a and a second tapered portion 27b are formed in a surface of the locking plate 21b on the side opposite to the side on which the handle portion 21a is disposed.

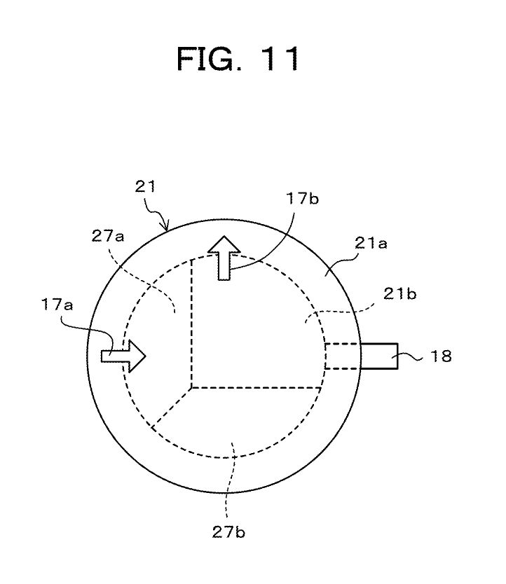

FIG. 11 illustrates an example of the positional relationship between the arrows, which are formed on the lock knob, and the tapered portions. As illustrated in FIG. 11, the first tapered portion 27a is located in an area corresponding to the arrow 17a of the handle portion 21a. A portion of the first tapered portion 27a on the center side of the locking plate 21b has a large thickness, and a portion of the first tapered portion 27a on the edge side of the locking plate 21b has a small thickness. The second tapered portion 27b is located at a position corresponding to an area on the side opposite to the side on which the arrow 17b is formed with the center of the handle portion 21a interposed between the area and the arrow 17b. Similar to the first tapered portion 27a, a portion of the second tapered portion 27b on the center side of the locking plate 21b has a large thickness, and a portion of the second tapered portion 27b on the edge side of the locking plate 21b has a small thickness.

An area on the locking plate 21b in which the first and second tapered portions 27a and 27b are not formed may hereinafter be referred to as a thick plate portion.

When the arrow 17a of the handle portion 21a is caused to be horizontally placed, the first tapered portion 27a is located on the front side (is located further toward the front end of the inner rail 13b than the connecting portion 21c), and the thick plate portion is located on the rear side (is located further toward the rear end of the inner rail 13b than the connecting portion 21c). When the arrow 17b of the handle portion is caused to be horizontally placed, the second tapered portion 27b is located on the rear side (is located further toward the rear end of the inner rail 13b than the connecting portion 21c).

The locking plate 21b is provided with a release bar 18 projecting in a radial direction of the locking plate 21b. When the handle portion 21a is rotated in such a manner that the arrow 17a indicating the direction in which the server 12 is mounted is caused to be horizontally placed, the release bar 18 is brought into contact with the stopper 22a and causes the stopper 22a to rotate. As a result, the end portion of the stopper 22a moves upward so as to be positioned above the hole 31a of the outer rail 13a and is brought into an unlocked state.

When the handle portion 21a is rotated in such a manner that the arrow 17b indicating the direction in which the server 12 is removed is caused to be horizontally placed, the release bar 18 is vertically positioned as illustrated in FIG. 8. The end portion of the stopper 22b is fitted into the hole 23b by an urging force of the spring 24, and the inner rail 13b and the outer rail 13a are locked together by the stopper 22b.

FIG. 12 illustrates an example of a server. FIG. 12 is a perspective view of one of the servers 12 to be mounted in the rack 11. FIG. 13 illustrates an example of a guide pin. FIG. 13 illustrates one of the guide pins 33 attached to the server 12.

As illustrated in FIG. 12, a release pin 32 and the plurality of guide pins 33 (three guide pins 33 in FIG. 12) are attached to both two side surfaces of the server 12. The guide pins 33 are disposed in such a manner as to be straight along the longitudinal direction of the side surfaces of the server 12. As illustrated in FIG. 13, each of the guide pins 33 has a shape formed by combining a large-diameter member having a disc-like shape (hereinafter referred to as the larger-diameter portion 33a) and a small-diameter member having a columnar shape (hereinafter referred to as the smaller-diameter portion 33b) together. The larger-diameter portion 33a is to be located in an area inside the inner rail 13b. Each of the release pins 32 is to be located at a position corresponding to the stopper 22a of the inner rail 13b.

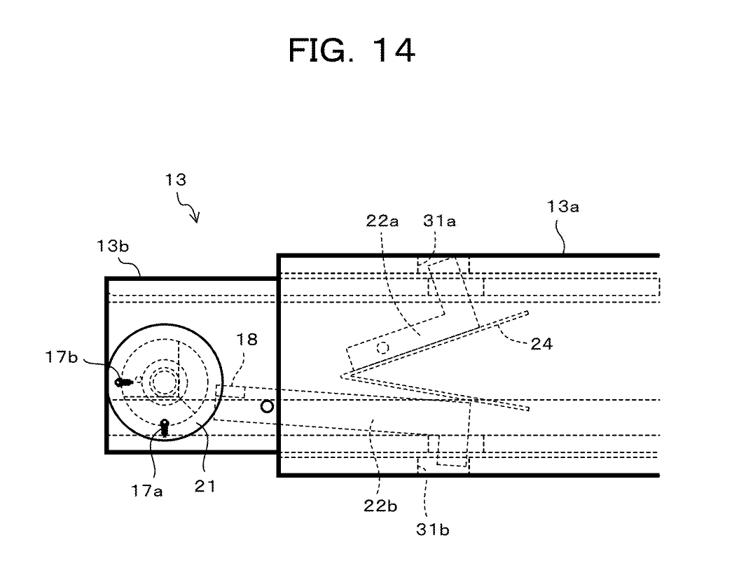

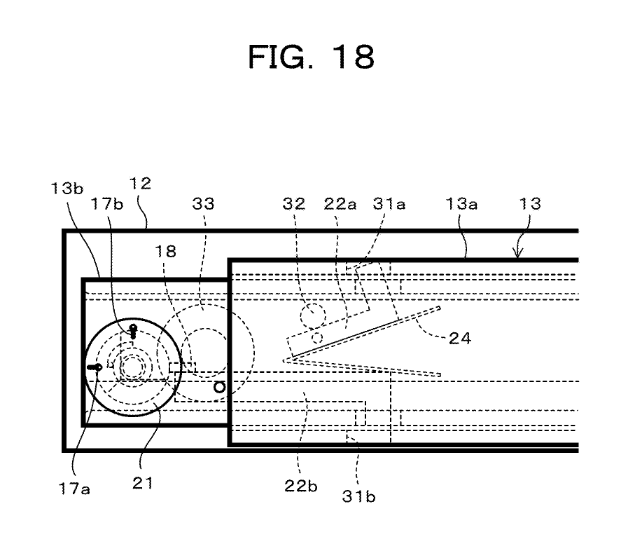

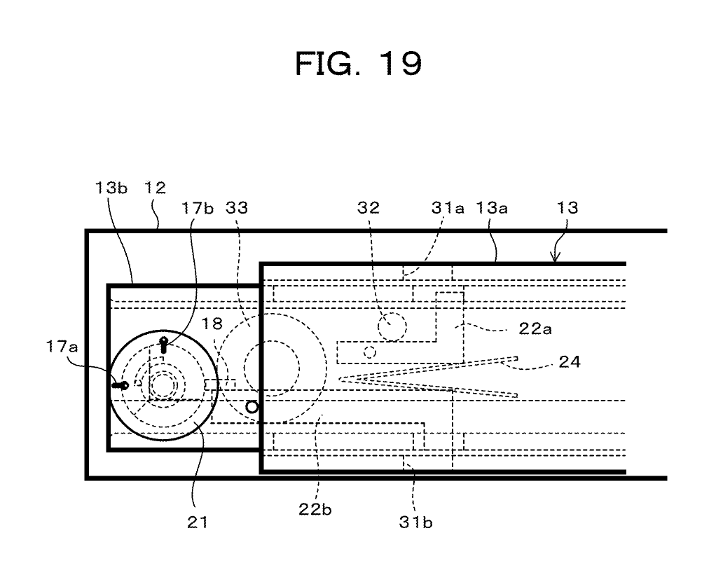

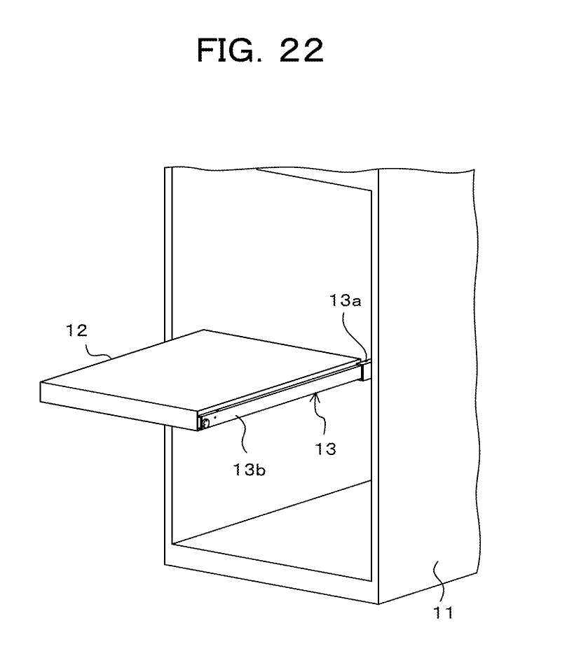

FIGS. 14 to 20 and FIGS. 21A to 21C each illustrate an exemplary method of using the slide rail (an exemplary method of mounting a server). FIG. 22 illustrates an exemplary state where a server has been pulled out from the rack.

For example, in an initial state, the inner rail 13b is accommodated in the corresponding outer rail 13a. As illustrated in FIG. 14, the arrow 17b of the lock knob 21 is oriented in the horizontal direction.

In this case, the release bar 18 of the lock knob 21 is vertically positioned. In this state, when the inner rail 13b is pulled out to about 10 cm, the end portions of the stoppers 22a and 22b are respectively fitted into the holes 31a and 31b of the outer rail 13a by the urging force of the spring 24, and the inner rail 13b and the outer rail 13a are locked together.

As illustrated in FIG. 12, the release pins 32 and the guide pins 33 are attached to the server 12.

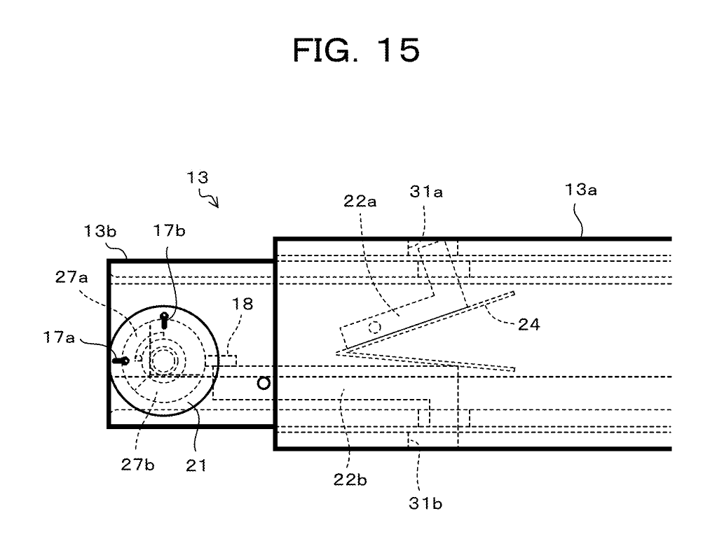

After that, as illustrated in FIG. 15, the lock knob 21 is rotated in such a manner that the arrow 17a of the lock knob 21 is oriented in the horizontal direction. As a result, the release bar 18 is caused to be horizontally placed and is brought into contact with the stopper 22b, and the end portion of the stopper 22b is moved so as to be positioned above the hole 31b of the outer rail 13a. For example, the locked state between the inner rail 13b and the outer rail 13a by the stopper 22b is released.

In this case, the end portion of the stopper 22a is fitted to the hole 31a of the outer rail 13a. Thus, the inner rail 13b is fixed (locked) to the outer rail 13a.

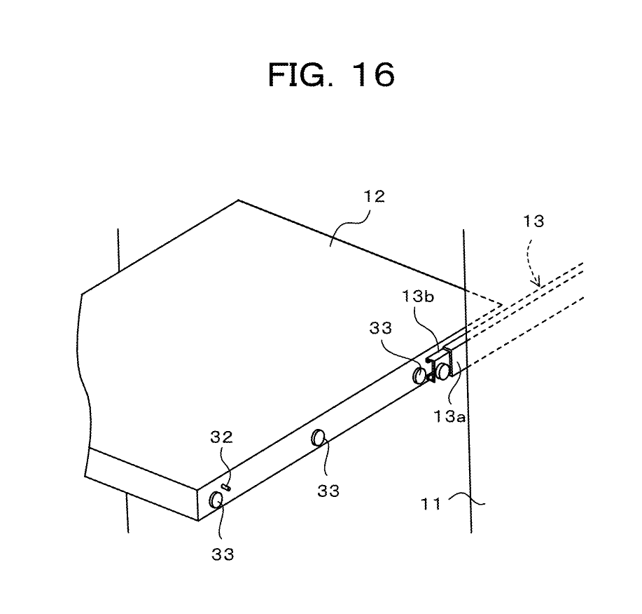

When the lock knob 21 is rotated in such a manner that the arrow 17a of the lock knob 21 is oriented in the horizontal direction, the first tapered portion 27a is located on the front side (is located further toward the front end of the inner rail 13b than the connecting portion 21c), and the thick plate portion is located on the rear side. In this state, as illustrated in FIG. 16, the guide pins 33 of the server 12 are inserted from the front end of the inner rail 13b.

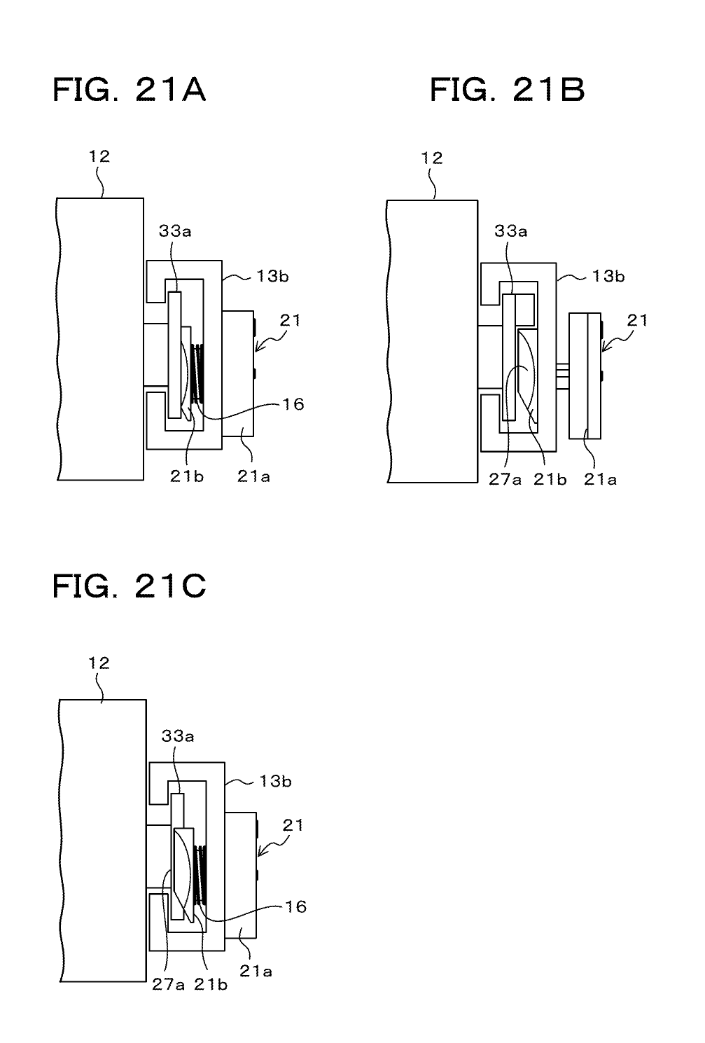

Each of FIGS. 21A to 21C illustrates the operation of the lock knob 21 along with movement of the guide pins 33.

When one of the guide pins 33 is inserted into the inner rail 13b, as illustrated in FIG. 21A, the larger-diameter portion 33a of the guide pin 33 is brought into contact with the first tapered portion 27a of the locking plate 21b.

When the guide pin 33 is inserted further deeply in the inner rail 13b by pushing the server 12, as illustrated in FIG. 21B, the larger-diameter portion 33a slides along a surface of the first tapered portion 27a along with movement of the guide pin 33 and laterally pushes away the locking plate 21b. As a result, the larger-diameter portion 33a of the guide pin 33 passes through the position of the locking plate 21b.

When the larger-diameter portion 33a of the guide pin 33 has passed through the position of the locking plate 21b as illustrated in FIG. 21C, the locking plate 21b is returned to the original position by an urging force of the coil spring 16.

In this manner, first, second, and third guide pins 33, each of which is attached to the corresponding side surface of the server 12, are sequentially inserted into the inner rail 13b. When the third guide pin 33 has passed through the locking plate 21b, the first guide pin 33 is brought into contact with the stopper 20 (see FIG. 5), which is disposed on the rear end side of the inner rail 13b, and the server 12 is hindered from moving further rearward. Consequently, the server 12 is clamped between the thick plate portion of the locking plate 21b and the stopper 20 and is brought into a state of being fixed to the inner rail 13b.

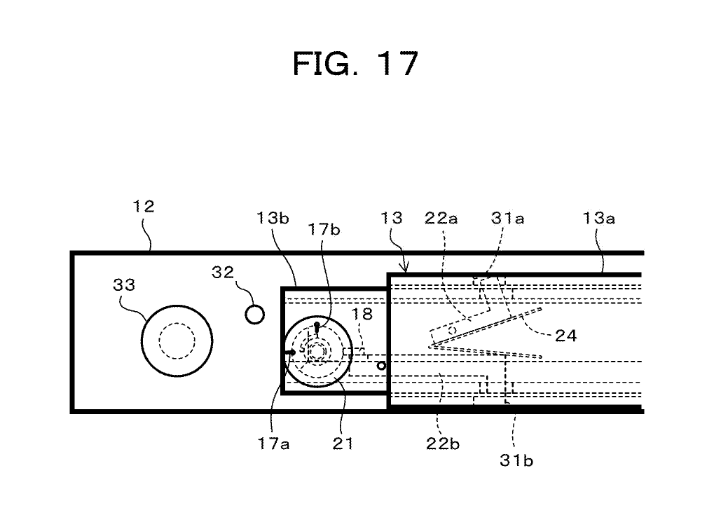

FIGS. 17 to 19 sequentially illustrate a state in which the third guide pin 33 is inserted into the inner rail 13b. As illustrated in FIGS. 17 to 19, when the third guide pin 33 is inserted into the inner rail 13b, the release pin 32 is brought into contact with the stopper 22a, and the end portion of the stopper 22a moves downward from the hole 31a of the outer rail 13a. As a result, the locked state between the inner rail 13b and the outer rail 13a by the stopper 22a is released.

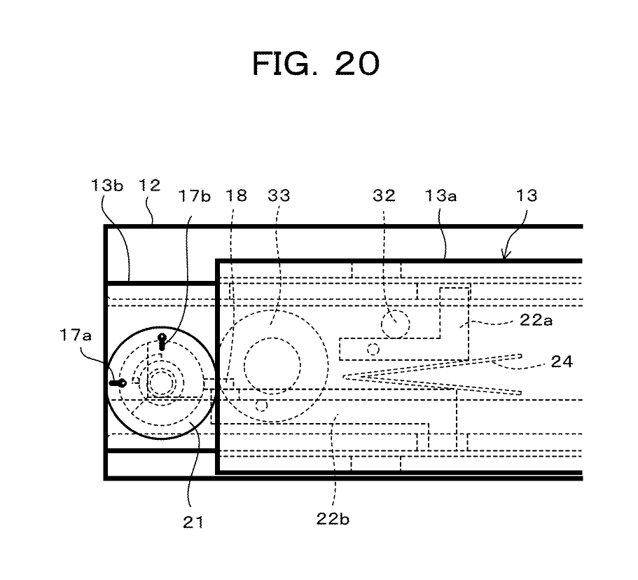

After that, when the server 12 has been pushed further rearward, as illustrated in FIG. 20, the inner rail 13b slides in the longitudinal direction of the outer rail 13a, and the server 12 and the inner rail 13b are accommodated in the rack 11.

In this state, when the server 12 has been pulled out forward, as illustrated in FIG. 22, the inner rail 13b slides along the outer rail 13a, and the server 12 may be pulled out from the rack 11. In addition, maintenance and inspection for the server 12 may be performed in this state.

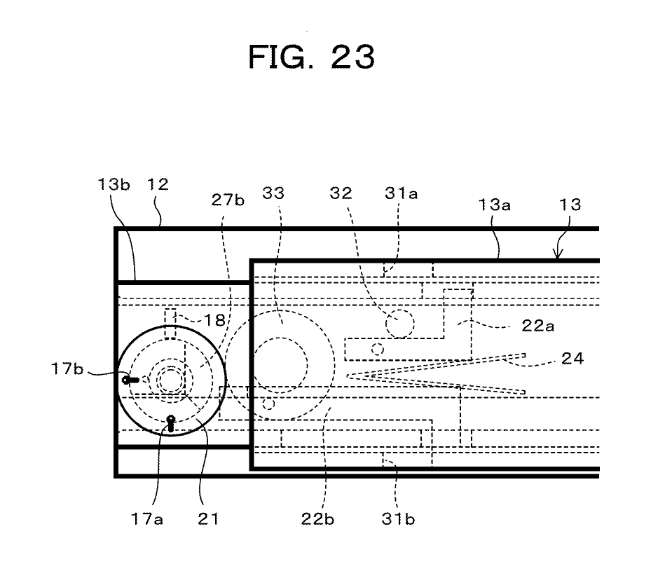

FIGS. 23 to 25 illustrate an exemplary operation for removing a server 12 from the slide rail. For example, in the initial state, the inner rail 13b is accommodated in the corresponding outer rail 13a.

As illustrated in FIG. 23, the lock knob 21 is rotated in such a manner that the arrow 17b of the lock knob 21 is oriented in the horizontal direction. As a result, the release bar 18 is vertically positioned, and the second tapered portion 27b of the lock knob 21 is located on the rear side (is located further toward the rear end of the inner rail 13b than the connecting portion 21c).

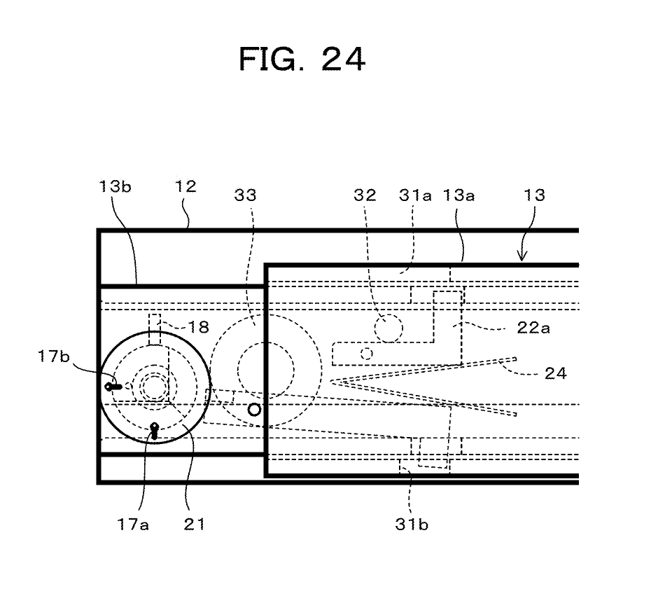

Subsequently, as illustrated in FIG. 24, the inner rail 13b is pulled out from the outer rail 13a to about 10 cm. The end portions of the stoppers 22a and 22b are respectively fitted into the holes 31a and 31b of the outer rail 13a by the urging force of the spring 24, and the inner rail 13b is fixed (locked) onto the outer rail 13a.

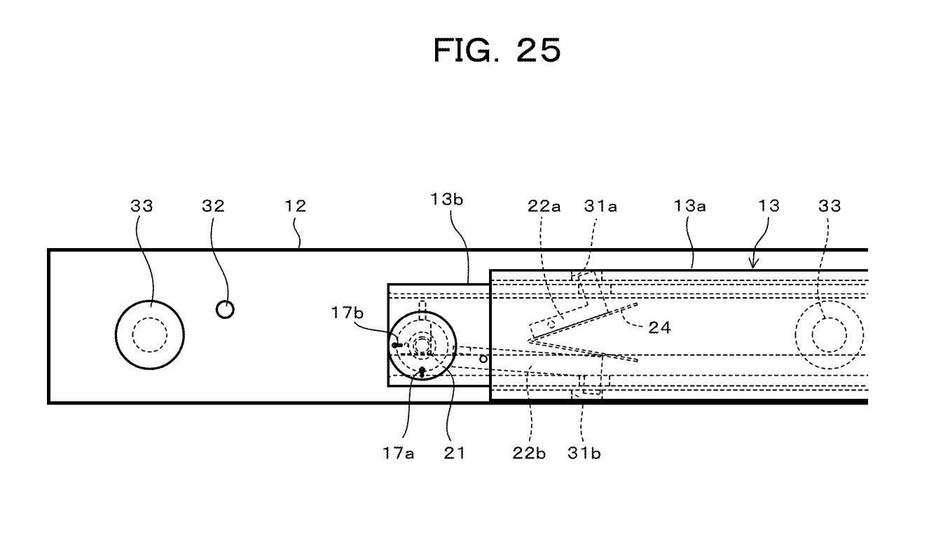

Then, as illustrated in FIG. 25, the server 12 is pulled out forward. When each of the guide pins 33 passes through the position of the locking plate 21b of the lock knob 21, the larger-diameter portion 33a slides along a surface of the second tapered portion 27b along with movement of the guide pin 33. The locking plate 21b is laterally pushed away by the larger-diameter portion 33a, and after the larger-diameter portion 33a has passed through the position of the locking plate 21b, the locking plate 21b is returned to the original position by the urging force of the coil spring 16 (see FIG. 9).

In this manner, the server 12 is removed from the slide rail 13.

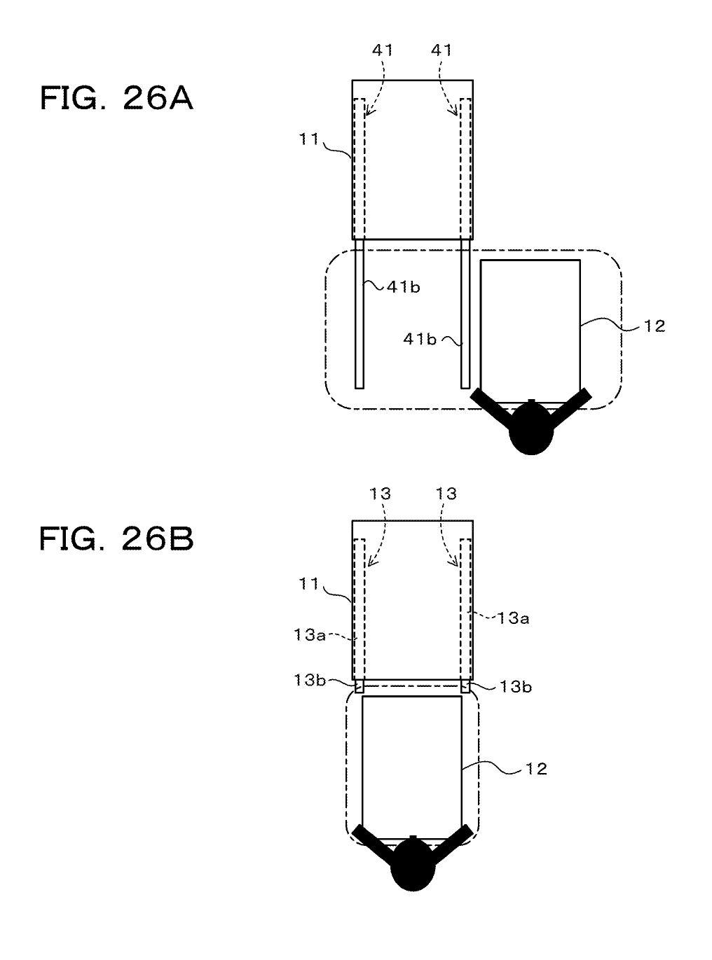

FIGS. 26A and 26B are exemplary top views of slide rails.

As illustrated in FIG. 26A, in the case of slide rails 41, inner rails 41b are pulled out from the rack 11 to a large extent, and one of the servers 12 is fixed onto the inner rails 41b. For example, when the inner rails 41b have been pulled out from the rack 11 to a large extent, there is a possibility that the inner rails 41b will swing in a left-right direction so that it will become difficult to perform an operation of fixing the server 12 onto the inner rails 41b. A large work space (an area surrounded by a one dot chain line in FIG. 26A) in front of the rack 11 may be used.

As illustrated in FIG. 26B, in the case of the slide rails 13, after the inner rails 13b have been slightly pulled out from the outer rails 13a to, for example, about 10 cm, the inner rails 13b are fixed onto the outer rails 13a by the stoppers 22a. Since one of the servers 12 is attached to the inner rails 13b in this state, the server 12 may be easily attached to the inner rails 13b without causing the inner rails 13b to swing in the lateral direction.

The server 12 may be attached to the inner rails 13b without pulling out the inner rails 13b from the outer rails 13a to a large extent. Therefore, a work space (an area surrounded by a one dot chain line in FIG. 26B) may be relatively small.

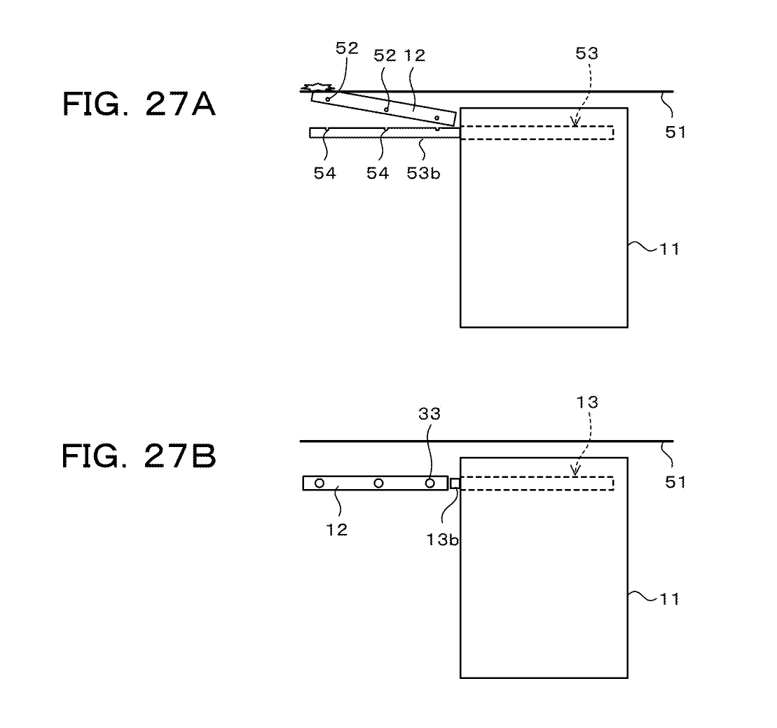

FIGS. 27A and 27B are exemplary side views of slide rails.

As illustrated in FIG. 27A, in the case of a slide rail 53, protrusions 52 are attached to the server 12, and receiving portions 54 that receive the protrusions 52 are formed in an inner rail 53b so that the server 12 may be easily attached to the inner rail 53b.

For example, in recent years, a large rack has been used in a data center in order to mount a large number of serves, and accordingly, the distance between such a large rack and the ceiling is small. Thus, as illustrated in FIG. 27A, in the case of performing an accommodating operation for accommodating the server 12 in the uppermost part of the rack 11, there is a possibility that the server 12 will be brought into contact with a ceiling 51 so that it will become difficult to perform the accommodating operation.

As illustrated in FIG. 27B, in the case of the slide rail 13, the server 12 is attached to the inner rail 13b by inserting the guide pins 33 from the front end of the inner rail 13b. Thus, even if the distance between the rack 11 and the ceiling 51 is small, the accommodating operation may be easily performed.

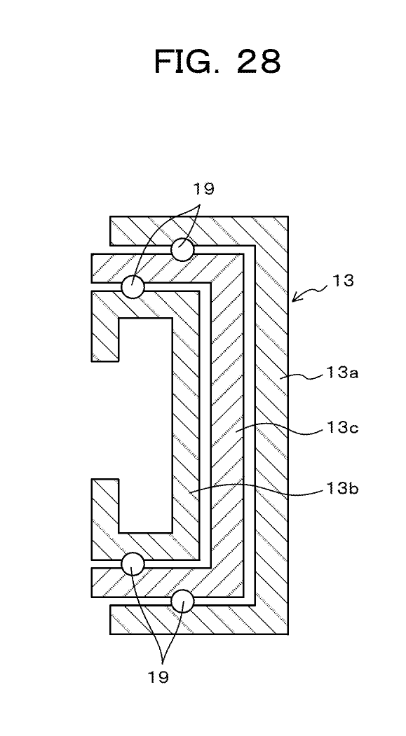

Each of the slide rails 13 includes the inner rail 13b and the outer rail 13a. FIG. 28 an exemplary longitudinal sectional view of one of the slide rails. For example, as illustrated in FIG. 28, the slide rail 13 may include an intermediate rail 13c disposed between the inner rail 13b and the outer rail 13a.

Electronic devices that are accommodated in the rack 11 or to-be-mounted objects that are connected to the slide rails 13 may be servers or other electronic devices. The above-described technology may be applied to slide rails that allow various to-be-mounted objects to be slidably accommodated in a housing.

For example, when the server 12 is not connected to left and right slide rails, the left and right slide rails move separately, and thus, the positions of the left and right slide rails may be adjusted separately. For example, in the case of the following left and right slide rails, the left and right slide rails operate together, and the server 12 may be easily fixed onto the left and right slide rails only by using one of the locking mechanisms of the left and right slide rails.

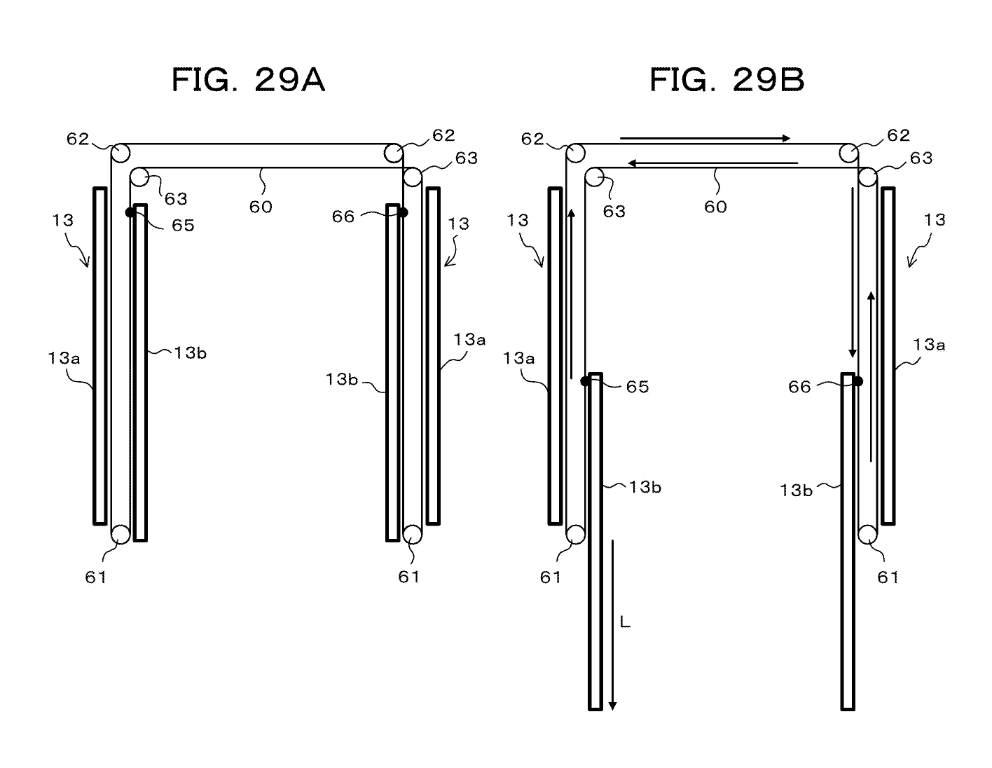

FIGS. 29A and 29B are diagrams illustrating an example of an interlocking mechanism of left and right slide rails.

For example, two slide rails 13 are each disposed on the left or right side of a rack, and one server is supported by the two left and right slide rails 13.

Each of the slide rails 13 illustrated in FIG. 29A includes the outer rail 13a that is fixed to a column of the rack and the inner rail 13b that slides in the longitudinal direction of the outer rail 13a.

Pulleys 61 are disposed in the front end of the corresponding outer rails 13a, and pulleys 62 and 63 are disposed in the rear end of the corresponding outer rails 13a. A wire member 60 is stretched in a loop shape by these pulleys so as to pass through the left pulley 61, the left pulley 62, the right pulley 62, the right pulley 61, the right pulley 63, and the left pulley 63 in this order and to return to the left pulley 61.

The pulleys 61, 62, and 63 may be examples of wire-laying members. A piece of metallic wire may be used as the wire member 60, or a piece of wire made of a resin may be used as the wire member 60.

The rear end portion of the left inner rail 13b is connected to a portion of the wire member 60 between one of the pulleys 61 and one of the pulleys 63. The rear end portion of the right inner rail 13b is connected to a portion of the wire member 60 between the other pulley 61 and one of the pulleys 62. In FIG. 29A, reference numeral 65 denotes a connecting portion in which the left inner rail 13b and the wire member 60 are connected to each other, and reference numeral 66 denotes a connecting portion in which the right inner rail 13b and the wire member 60 are connected to each other.

For example, as illustrated in FIG. 29B, the left inner rail 13b is pulled out forward by a distance L. The connecting portion 65 is also caused to move forward by the distance L, and along with this, the wire member 60, which is stretched by the pulleys 61, 62, and 63, is caused to move in the directions of arrows in FIG. 29B. Accordingly, the connecting portion 66 is also caused to move forward by the distance L, and along with this, the right inner rail 13b is also caused to move forward by the distance L.

Although the slide rails 13 that include the outer rail 13a and the inner rail 13b are illustrated in FIG. 29A and FIG. 29B, the technique disclosed herein may be applied to slide rails that include outer rails, inner rails, and intermediate rails. In this case, two pairs of the interlocking mechanisms illustrated in FIG. 29A and FIG. 29B may be used.

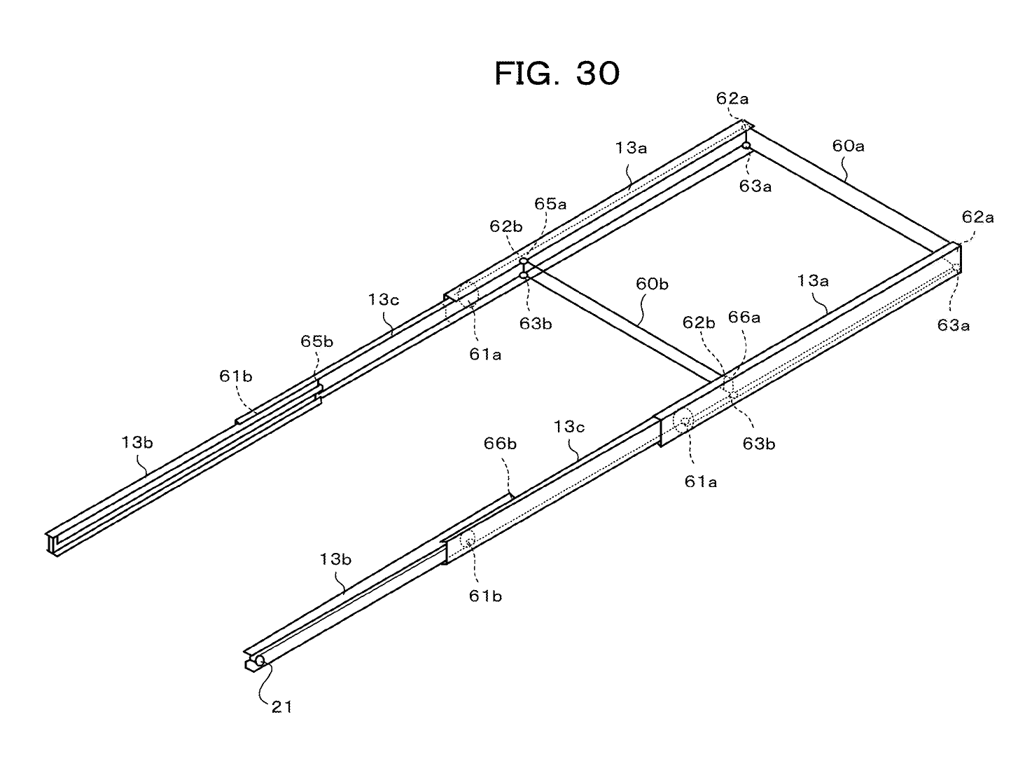

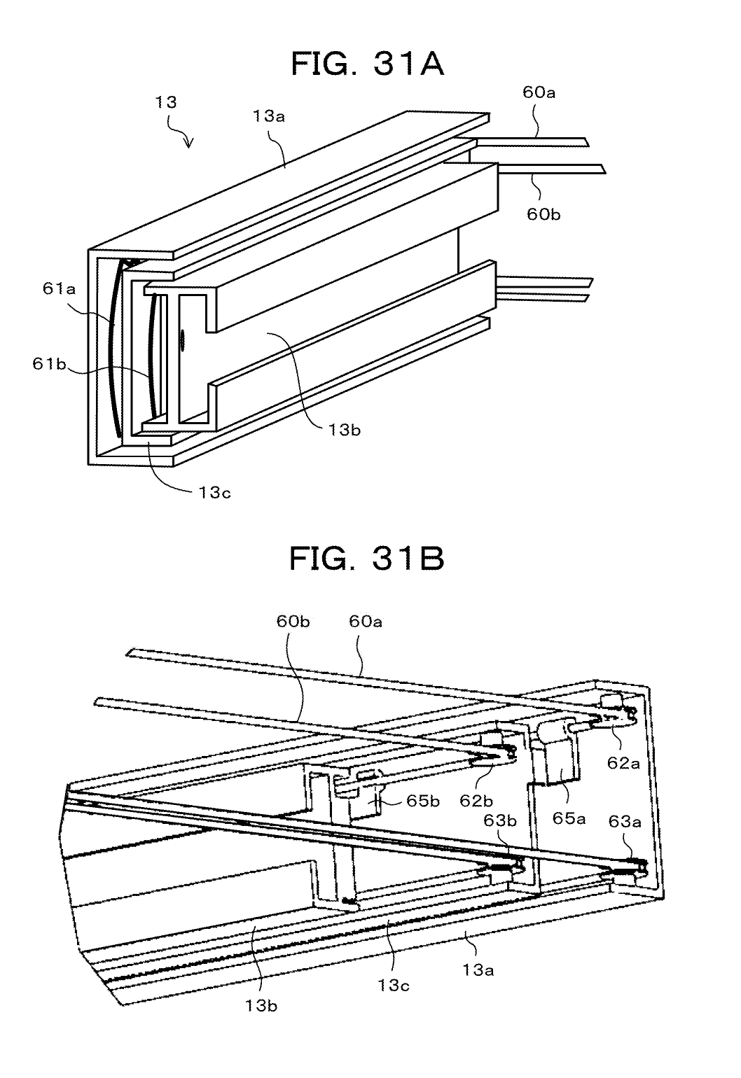

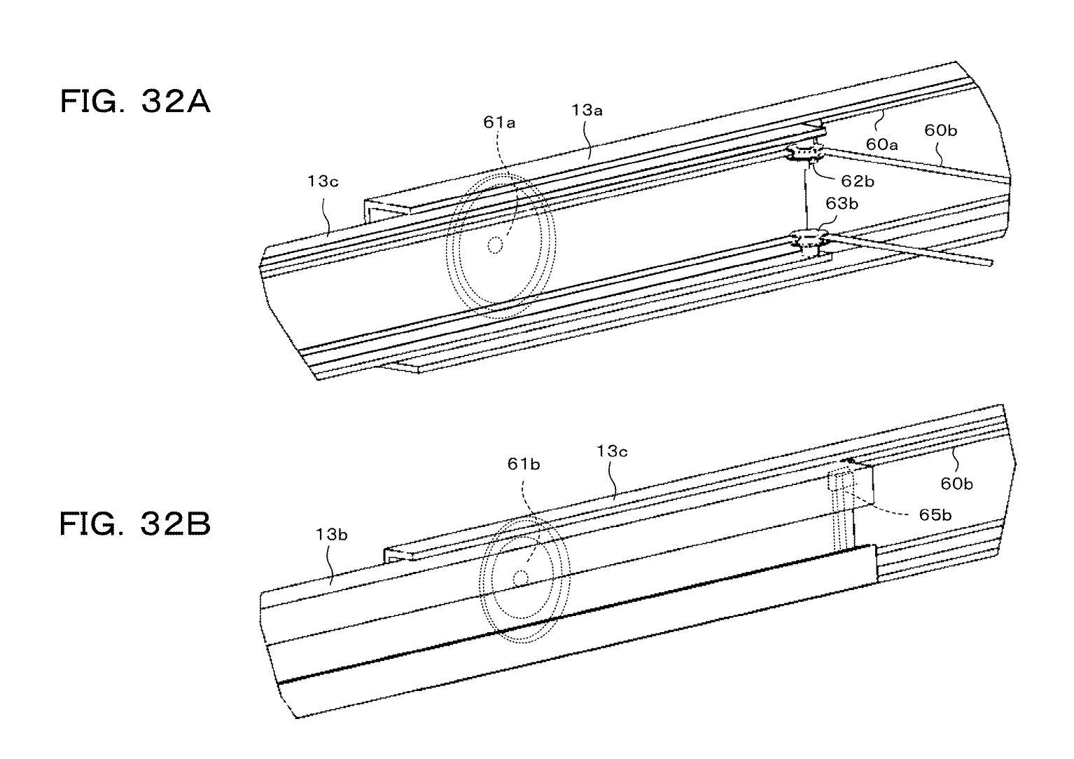

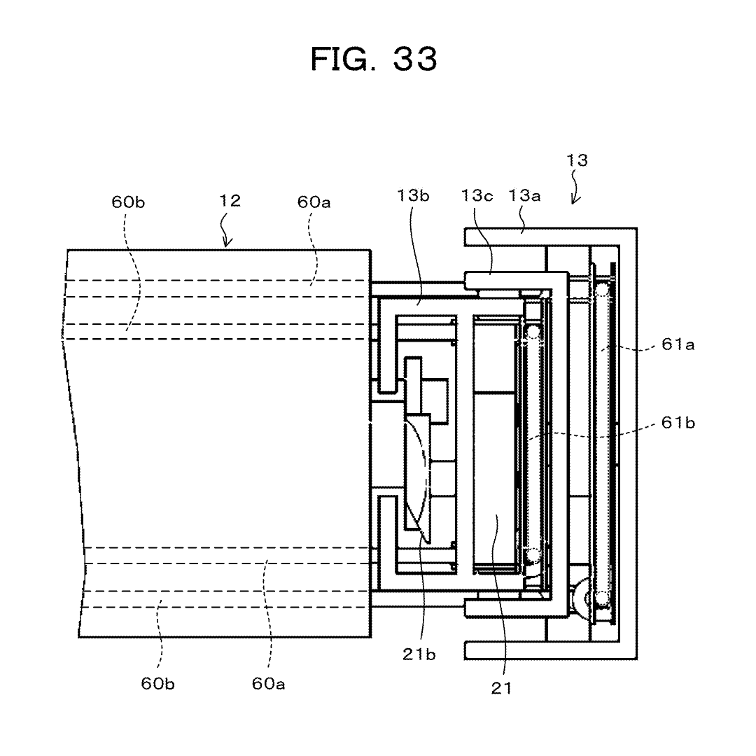

FIG. 30 illustrates an example of slide rails. In FIG. 30, an interlocking mechanism is applied to the slide rails 13 that include the outer rails 13a, the inner rails 13b, and the intermediate rails 13c. FIGS. 31A and 31B and FIGS. 32A and 32B are exemplary perspective views each illustrating one of the slide rails. Each of FIGS. 31A and 31B and FIGS. 32A and 32B illustrate perspective views of the slide rail 13 as seen from different angles. FIG. 33 illustrates an example of a locking mechanism. FIG. 33 illustrates a plan view of a locking mechanism provided in the right slide rail 13.

FIG. 30 illustrates a state where the slide rails 13 have been extended. Each of FIG. 31A and FIG. 31B illustrates a state where the slide rails 13 have been retracted. Each of FIGS. 32A and 32B illustrates a state where the slide rails 13 are in the process of being extended.

Although FIGS. 31A and 31B and FIGS. 32A and 32B illustrate the left inner rail 13b, the right inner rail 13b may have a configuration similar to that of the left inner rail 13b. For example, the right slide rail 13 may be provided with the above-mentioned locking mechanism while the left slide rail 13 is not provided with the locking mechanism.

As illustrated in FIG. 30, pulleys 61a are disposed in front end portions of the outer rails 13a. The rotary shafts of the pulleys 61a are supported by the corresponding outer rails 13a. Pulleys 62a and 63a are disposed in rear end portions of the outer rails 13a. The rotary shafts of the pulleys 62a and 63a are also supported by the corresponding outer rails 13a.

A wire member 60a is stretched in a loop shape by the pulleys 61a, 62a, and 63a that are supported by the left outer rail 13a and the pulleys 61a, 62a, and 63a that are supported by the right outer rail 13a (see FIGS. 29A and 29B).

The left intermediate rail 13c is connected to a portion of the wire member 60a between one of the pulleys 61a and one of the pulleys 63a in a connecting portion 65a that is formed in a rear end portion of the left intermediate rail 13c. The right intermediate rail 13c is connected to a portion of the wire member 60a between the other pulley 61a and one of the pulleys 62a in a connecting portion 66a that is formed in a rear end portion of the right intermediate rail 13c. Therefore, the left and right intermediate rails 13c move forward and rearward together.

Pulleys 61b are disposed in the front end portions of the intermediate rails 13c. The rotary shafts of the pulleys 61b are supported by the corresponding intermediate rails 13c. Pulleys 62b and 63b are disposed in the rear end portions of the intermediate rails 13c. The rotary shafts of the pulleys 62b and 63b are also supported by the corresponding intermediate rails 13c.

A wire member 60b is stretched in a loop shape by the pulleys 61b, 62b, and 63b that are supported by the left intermediate rail 13c and the pulleys 61b, 62b, and 63b that are supported by the right intermediate rail 13c (see FIGS. 29A and 29B).

The left inner rail 13b is connected to a portion of the wire member 60b between one of the pulleys 61b and one of the pulleys 63b in a connecting portion 65b that is formed in the rear end portion of the left inner rail 13b. The right inner rail 13b is connected to a portion of the wire member 60b between the other pulley 61b and one of the pulleys 62b in a connecting portion 66b that is formed in the rear end portion of the right inner rail 13b. Therefore, the left and right of inner rails 13b move forward and rearward together.

The connecting portions 65a and 66a and the wire member 60a are connected to one another by, for example, applying pressure, and the connecting portions 65b and 66b and the wire member 60b are connected to one another by, for example, applying pressure.

By using two pairs of interlocking mechanisms, the intermediate rails 13c of the left and right slide rails 13 move forward and rearward together, and the inner rails 13a of the left and right slide rails 13 move forward and rearward together. The right slide rail 13 is provided with the locking mechanism including the handle portion 21a, the locking plate 21b, and the like. Therefore, an operation of attaching one of the servers 12 to the slide rails 13 may be easily performed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A slide rail comprising:
an outer rail;
an inner rail, including a space into which a guide pin, which is attached to a to-be-mounted object, is capable of being inserted from one end side of the inner rail, configured to slide in a longitudinal direction of the outer rail; and
a locking mechanism configured to fix the inner rail onto the outer rail.

2. The slide rail according to claim 1,
wherein the locking mechanism includes:
a first stopper, provided in the inner rail, configured to be urged toward the outer rail;
a second stopper, provided in the inner rail, configured to be urged toward the outer rail;
a first engagement portion, formed at a first position in the outer rail, configured to engage with the first stopper; and
a second engagement portion, formed at a second position in the outer rail, configured to engage with the second stopper.

3. The slide rail according to claim 1,
wherein the locking mechanism includes:
a first stopper configured to project from a first hole formed in a first surface of the inner rail toward the outer rail; and
a second stopper configured to project from a second hole formed in a second surface of the inner rail opposite to the first surface toward the outer rail.

4. The slide rail according to claim 1, further comprising:
a handle portion disposed outside the inner rail;
a locking plate disposed in the space of the inner rail;
a connecting portion configured to be rotatably supported by a side plate of the inner rail and connect the handle portion and the locking plate to each other; and
a spring configured to urge the locking plate in a direction away from the side plate of the inner rail.

5. The slide rail according to claim 2, further comprising:
a locking plate disposed in the space of the inner rail; and
a release bar configured to operate together with the locking plate and release an engagement of the second stopper and the second engagement portion by coming into contact with the second stopper.

6. The slide rail according to claim 4,
wherein the locking plate includes:
a tapered portion along which the guide pin slides when the guide pin passes through the space of the inner rail.

7. The slide rail according to claim 2,
wherein an engagement of the first stopper and the first engagement portion is released by a release pin that is attached to a position on the to-be-mounted object.

8. The slide rail according to claim 1, further comprising:
two pairs of the inner rails and two pairs of the outer rails; and
an interlocking mechanism configured to cause the two pairs of the inner rails to move forward and rearward in an interlocked manner.

9. The slide rail according to claim 8,
wherein the locking mechanism is included in only one of the two pairs of the inner rails.

10. The slide rail according to claim 8,
wherein the interlocking mechanism includes:
a loop-shaped wire member stretched between the two pairs of the inner rails; and
a wire-laying member configured to be used for laying the wire member along a path.

11. An electronic apparatus comprising:
a housing;
an electronic device including a guide pin and a release pin and disposed in the housing; and
a slide rail disposed between the housing and the electronic device,
wherein the slide rail includes:
an outer rail fixed to the housing;
an inner rail, including a space into which the guide pin is capable of being inserted from one end side of the inner rail, configured to slide in a longitudinal direction of the outer rail and
a locking mechanism configured to fix the inner rail onto the outer rail.

12. The electronic apparatus according to claim 11,
wherein the locking mechanism includes:
a first stopper, provided in the inner rail, configured to be urged toward the outer rail;
a second stopper, provided in the inner rail, configured to be urged toward the outer rail;
a first engagement portion, formed at a first position in the outer rail, configured to engage with the first stopper; and
a second engagement portion, formed at a second position in the outer rail, configured to engage with the second stopper.

13. The electronic apparatus according to claim 11,
wherein the locking mechanism includes:
a first stopper configured to project from a first hole formed in a first surface of the inner rail toward the outer rail; and
a second stopper configured to project from a second hole formed in a second surface of the inner rail opposite to the first surface toward the outer rail.

14. The electronic apparatus according to claim 11, further comprising:
a handle portion disposed outside the inner rail;
a locking plate disposed in the space of the inner rail;
a connecting portion configured to be rotatably supported by a side plate of the inner rail and connect the handle portion and the locking plate to each other; and
a spring configured to urge the locking plate in a direction away from the side plate of the inner rail.

15. The electronic apparatus according to claim 12, further comprising:
a locking plate disposed in the space of the inner rail; and
a release bar configured to operate together with the locking plate and release an engagement of the second stopper and the second engagement portion by coming into contact with the second stopper.

16. The electronic apparatus according to claim 14,
wherein the locking plate includes a tapered portion, and, when the guide pin passes through the space of the inner rail, the guide pin comes into contact with the tapered portion such that the locking plate is caused to move toward the side plate of the inner rail.

17. The electronic apparatus according to claim 12,
wherein, when the guide pin is inserted so as to be located at a position in the space of the inner rail, the release pin is brought into contact with the first stopper such that an engagement of the first stopper and the first engagement portion is released.

18. The electronic apparatus according to claim 11, further comprising:
two pairs of the slide rails disposed between the housing and the electronic device;
a loop-shaped wire member stretched between the inner rails of the two pairs of the slide rails;
a wire-laying member configured to be used for laying the wire member along a path; and
an interlocking mechanism configured to cause the inner rails of the two pairs of the slide rails to move forward and rearward in an interlocked manner.
